(19) United States
(12) Patent Application Publication
(10) Pub. No.: US 2025/0263283 A1
(43) Pub. Date: Aug. 21, 2025

(54) INJECTION SYSTEM

(71) Applicant: Clear IP Corporation, Stafford, TX (US)

(72) Inventor: Jeff WU, Stafford, TX (US)

(73) Assignee: Clear IP Corporation, Stafford, TX (US)

(21) Appl. No.: 19/054,062

(22) Filed: Feb. 14, 2025

Related U.S. Application Data
(60) Provisional application No. 63/556,145, filed on Feb. 21, 2024.

(51) Int. Cl. B67C 3/26

(52) U.S. Cl. CPC B67C 3/26

(57) ABSTRACT

An injection system is provided. A fluid reservoir is operable to contain a fluid. The fluid reservoir has a reservoir width, and the fluid reservoir including an outlet opening that has an outlet width. The outlet width is greater than 20% of the reservoir width. An injection pump coupled to the fluid reservoir includes a passageway in fluid communication with the outlet opening such that the passageway is operable to receive the fluid from the fluid reservoir via the outlet opening. The injection pump is operable to dispense the fluid from the passageway through a pump outlet. T conduit in fluid communication with the injection pump forms a channel operable to receive the fluid dispensed from the passageway. The channel is operable to permit the fluid to flow therethrough. The passageway and the channel extend linearly along a longitudinal axis.

### CROSS-REFERENCE TO RELATED APPLICATION

This application claims the benefit of U.S. Provisional Patent Application No. 63/556,145, filed in the U.S. Patent and Trademark Office on Feb. 21, 2024, which is incorporated herein by reference in its entirety for all purposes.

### TECHNICAL FIELD

The present disclosure relates generally to systems and techniques for filling containers with fluid.

### BACKGROUND

Since the legalization of hemp and related products in the USA many formants of consumption have arisen. Vaporization, edibles, and topicals are all delivery methods for ingestion. The creation of hemp and related concentrates have created a market for high potency products that can either be pyrolyzed or ingested which are particularly popular for medical and chronic pain patients. This market demand has created a supply chain struggling to supply products due to the difficult and often hard-to-package concentrate product that is sold by the gram.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof, which are illustrated in the appended drawings. Understand that these drawings depict only exemplary embodiments of the disclosure and are not, therefore, to be considered to be limiting of its scope, the principles herein are described and explained with additional specificity and detail through the use of the accompanying drawings in which:

FIG. 1A is a perspective view of an example injection assembly;

FIG. 1B is a perspective view of the injection assembly of FIG. 1A;

FIG. 2 is a schematic diagram of a controller which may be employed as shown in FIGS. 1A-1B;

FIG. 3A illustrates a perspective view of a load cell component;

FIG. 3B illustrates a front elevational view of the load cell component;

FIG. 3C illustrates a perspective view of the load cell component;

FIG. 4 is a perspective view of an injection system;

FIG. 5A is a cross-sectional view of the injection system, with the injection pump in a withdrawn configuration;

FIG. 5B is a cross-sectional view of the injection system, with the injection pump in an extended configuration;

FIG. 5C is a top perspective view of the injection system;

FIG. 5D is a cross-sectional view of the injection of FIG. 5C, taken along lines 5D-5D;

FIG. 6 is a perspective view of a diagram of the injection system;

FIG. 7A is an enlarged view of a tip and a conduit of the injection system;

FIG. 7B is a side view of the tip; and

FIG. 8 is a flow chart of a method of pumping a fluid for filling containers.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure. Additional features and advantages of the disclosure will be outlined in the description which follows, and in part will be obvious from the description, or can be learned by practice of the herein disclosed principles. It will be appreciated that for simplicity and clarity of illustration, where appropriate, reference numerals have been repeated among the different figures to indicate corresponding or analogous elements. The description is not to be considered as limiting the scope of the embodiments described herein.

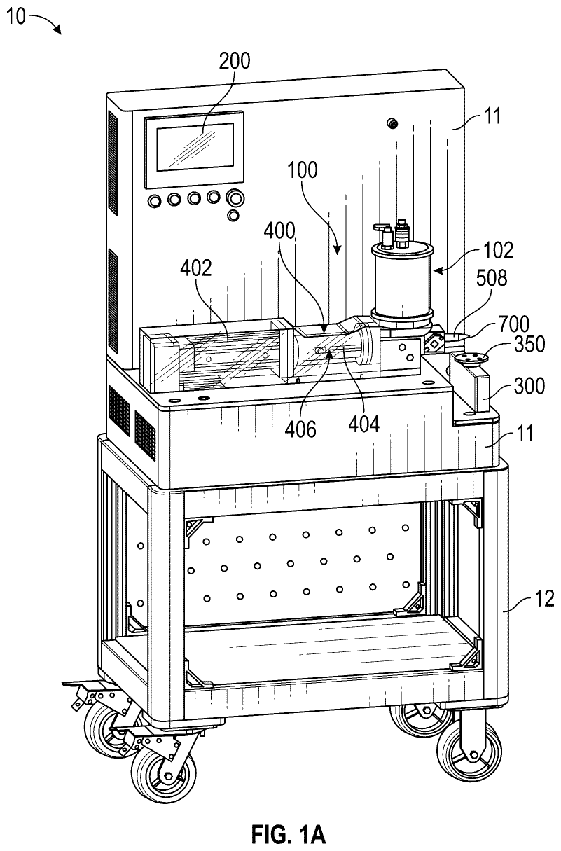

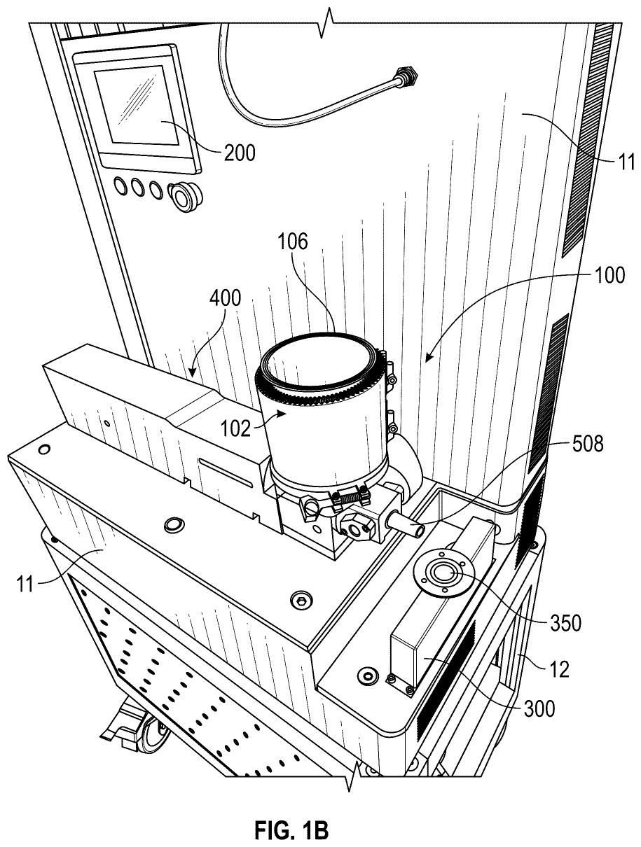

FIG. 1A illustrates a perspective view of an example injection assembly 10. In at least one example, the injection assembly 10 is used to dispense accurate amounts of fluid into a container 350. Container 350 can be a special purpose jar or a commercially available jar. An injection system 100 can be configured to dispense fluids (e.g., resin, oil, and/or terpene fluids) stored in a reservoir 102 to container 350. For example, an injection pump 400 can be operable to cause the fluid in the reservoir 102 to flow out of a tip 700 and into the container 350. While the injection system 100 is operating, a load cell 300 can determine the total weight in real-time. A controller 200 can receive data (e.g., from the load cell 300) indicative of the total weight and send a signal to stop the injection system 100 and/or send a signal to the injection system 100 to dispense an amount of the fluid. The controller 200 can be a PLC or Computer system with an interface. Additional details about the reservoir 102, controller 200, container 350, load cell 300, and injection pump 400 are given below with respect to the additional figures.

As illustrated in FIGS. 1A and 1B, the injection assembly 10 can have a base 11. The base 11 can be sized to be placed on a tabletop (not shown). The base 11 in other implementations can be floor mounted. The base 11 can function as a balancing base in that the base 11 serves to balance the components and provide some stability as the various components move and/or operate. The controller 200 can be coupled with the base 11. In other examples, the controller 200 can be wirelessly coupled to the components and separate from the assembly. The fluid reservoir 102 can be coupled to the base 11. The fluid reservoir 102 can be omitted when the concentrate filling system 10 is implemented without a separate fluid filling component such as the injection pump 400. The fluid reservoir 102 stores oils that can be added through the injection pump 400. The fluid reservoir 102 can include one or more heating and/or cooling components to control the temperature of the oil in the fluid reservoir 102.

The concentrate filling system 10 includes a load cell 300. The load cell 300 can be operable to be zeroed using a container 350. Container 350 can be filled by the injection pump 400 in a systematic way so that a density of the particles that are within the container 350 can be measured. The conveyor 400 can also be coupled to base 11. The injection pump 400 can be coupled to the fluid reservoir 102. In other examples, the injection pump 400 can be coupled directly to the base 11. The fluid reservoir 102 is also fluidically coupled with the injection pump 400 such that fluid can flow from the fluid reservoir 102 to the injection pump 400 and thereby be dispensed from the injection pump 400 into the container 350.

The solid loader 600 can also be coupled to the base 11. By having all of the components coupled to the base 11, the concentrate filling system 10 can be designed to be installed within an existing facility on a tabletop.

As illustrated in FIGS. 1A and 1B, in some examples, the injection system 100 can be positioned on a platform 12. The platform 12 can receive and hold the injection system 100 in a raised position for easier access and control for the operator. In some examples, as illustrated in FIG. 1A, the platform 12 can be moveable. For example, the platform 12 can include wheels so that the platform 12 and the injection system 100 can be easily moved to any desired location.

In at least one example, the injection assembly 10 can be designed and assembled prior to shipping. In another example, the load cell 300 can be separated and packaged together with, but physically not assembled with the other components of the injection assembly 10. Additionally, the controller 200 can be arranged to be mounted directly to the base 11 as shown. In other examples, the controller 200 can be mounted on a stand and/or located on the back side of the base 11.

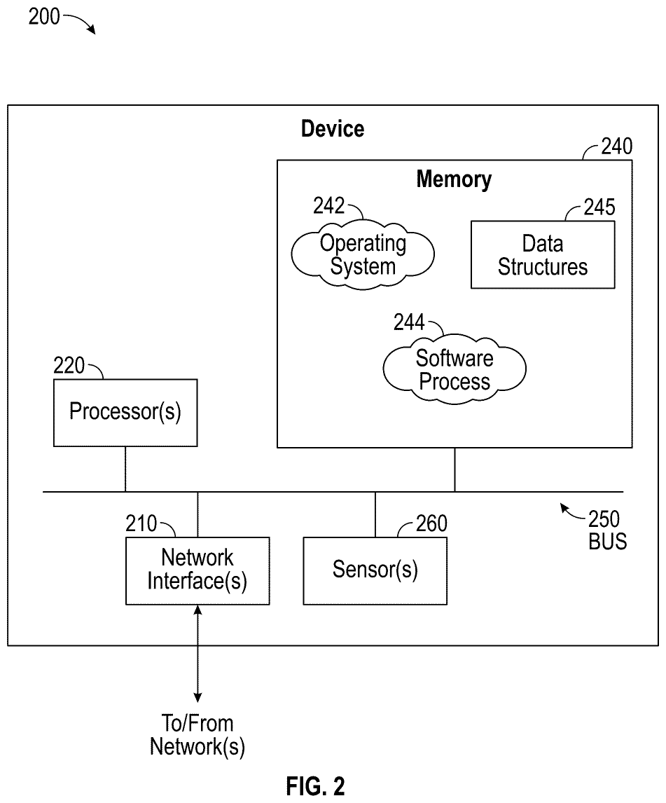

FIG. 2 is a block diagram of an exemplary controller 200. Controller 200 is configured to perform processing of data and communicate with the injection system 100. For example, the controller 200 can be operable to receive data from the load cell 300 indicative of the weight of the fluid and send a control signal to the injection system 100 to adjust the dispensing of the fluid. In some examples, the controller 200 is operable upon receiving indicative of a predetermined weight of the container, fluid, and particles the controller is operable to send a control signal to the conveyor and the injection pump to stop dispensing of fluid. In some examples, the controller 200 includes a display screen. The display screen can be operable to display information including the weight of the container 350 including the contents. Furthermore, the display information can include system settings, density, cycle time, fill settings, solid settings, and heat settings.

In operation, controller 200 communicates with one or more of the components discussed herein and may also be configured to communication with remote devices/systems.

As shown, controller 200 includes hardware and software components such as network interfaces 210, at least one processor 220, sensors 260 and a memory 240 interconnected by a system bus 250. Network interface(s) 210 can include mechanical, electrical, and signaling circuitry for communicating data over communication links, which may include wired or wireless communication links. Network interfaces 210 are configured to transmit and/or receive data using a variety of different communication protocols, as will be understood by those skilled in the art.

Processor 220 represents a digital signal processor (e.g., a microprocessor, a microcontroller, or a fixed-logic processor, etc.) configured to execute instructions or logic to perform tasks for the injection assembly 10. Processor 220 may include a general purpose processor, special-purpose processor (where software instructions are incorporated into the processor), a state machine, application specific integrated circuit (ASIC), a programmable gate array (PGA) including a field PGA, an individual component, a distributed group of processors, and the like. Processor 220 typically operates in conjunction with shared or dedicated hardware, including but not limited to, hardware capable of executing software and hardware. For example, processor 220 may include elements or logic adapted to execute software programs and manipulate data structures 245, which may reside in memory 240.

Sensors 260 typically operate in conjunction with processor 220 to perform measurements, and can include special-purpose processors, detectors, transmitters, receivers, and the like. In this fashion, sensors 260 may include hardware/software for generating, transmitting, receiving, detection, logging, and/or sampling parameters.

Memory 240 comprises a plurality of storage locations that are addressable by processor 220 for storing software programs and data structures 245 associated with the embodiments described herein. An operating system 242, portions of which may be typically resident in memory 240 and executed by processor 220, functionally organizes the device by, inter alia, invoking operations in support of software processes and/or services 244 executing on controller 200. These software processes and/or services 244 may perform processing of data and communication with controller 200, as described herein. Note that while process/service 244 is shown in centralized memory 240, some examples provide for these processes/services to be operated in a distributed computing network.

It will be apparent to those skilled in the art that other processor and memory types, including various computer-readable media, may be used to store and execute program instructions pertaining to the fluid injection techniques described herein. Also, while the description illustrates various processes, it is expressly contemplated that various processes may be embodied as modules having portions of the process/service 244 encoded thereon. In this fashion, the program modules may be encoded in one or more tangible computer readable storage media for execution, such as with fixed logic or programmable logic (e.g., software/computer instructions executed by a processor, and any processor may be a programmable processor, programmable digital logic such as field programmable gate arrays or an ASIC that comprises fixed digital logic. In general, any process logic may be embodied in processor 220 or computer readable medium encoded with instructions for execution by processor 220 that, when executed by the processor, are operable to cause the processor to perform the functions described herein.

Additionally, the controller 200 can apply machine learning, such as a neural network or sequential logistic regression and the like, to determine relationships between the injection system 100 and the fluid. For example, a deep neural network may be trained in advance to capture the complex relationship between the injection pump 400, the movement of the fluid from the reservoir 102 and out of the tip 700 into the container 350. This neural net can then be deployed in the estimation of fluid injection. As such, the determination of the amount of fluid that is being dispensed can be more accurate.

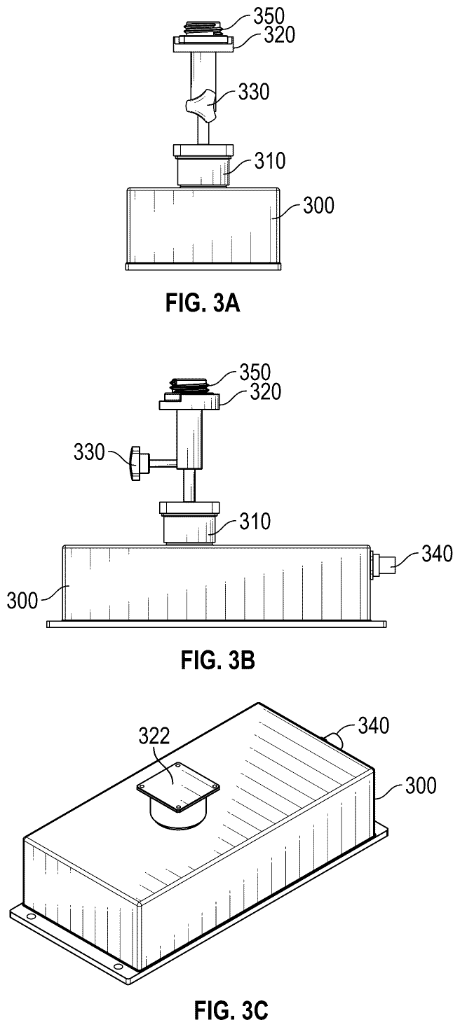

FIG. 3A illustrates a side elevational view of a load cell 300. FIG. 3B illustrates a front elevational view of a load cell 300. The load cell 300 is operable to receive a container 350. Container 350 receives the dispensed fluid from the injection system 100. The load cell 300 can be configured with different attachment dies 320 designed to properly seat different containers on the load cell 300. The attachment dies 320 can be secured to the load cell using an affixment device 330. The attachment dies 320 allow for the container 350 to be quickly centered thereby allowing for accurate measurements by the load cell 300. In at least one example, the affixment device 330 can be a screw that connects to the load cell 300. Additionally, the load cell includes platform 310 and port 340. Port 340 can be coupled to a cord that is operable to transfer data and/or power to the load cell 300 and/or from the load cell 300. The platform 310 can be operable to receive the attachment dies 320 which allow for accurate centering of mass for weight measurement.

The load cell 300 is operable to move in response to one or more signals from the controller and take additional measurements and send additional measurement data to the controller, which is operable to determine a density of a mixture in the container. In at least one example the movement of the load cell 300 is a series of four strokes.

FIG. 3C illustrates a prospective view of another load cell 300. The load cell 300 includes a platform 322 to which different types of attachment dies 320 can be coupled thereto. In other examples, the platform 322 can be used directly to put a container 350 on. Dies can also be shaped to specific containers to allow for faster loading and unloading. In some examples, the containers can be shaped differently such as a square shape or hexagonal shape. In those examples, different shape dies can be implemented. Furthermore, some dies can be shaped that allow for a variety of different containers.

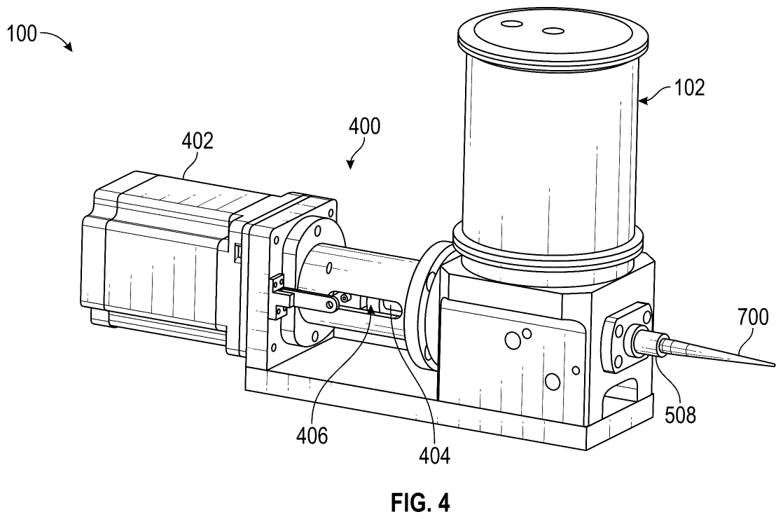

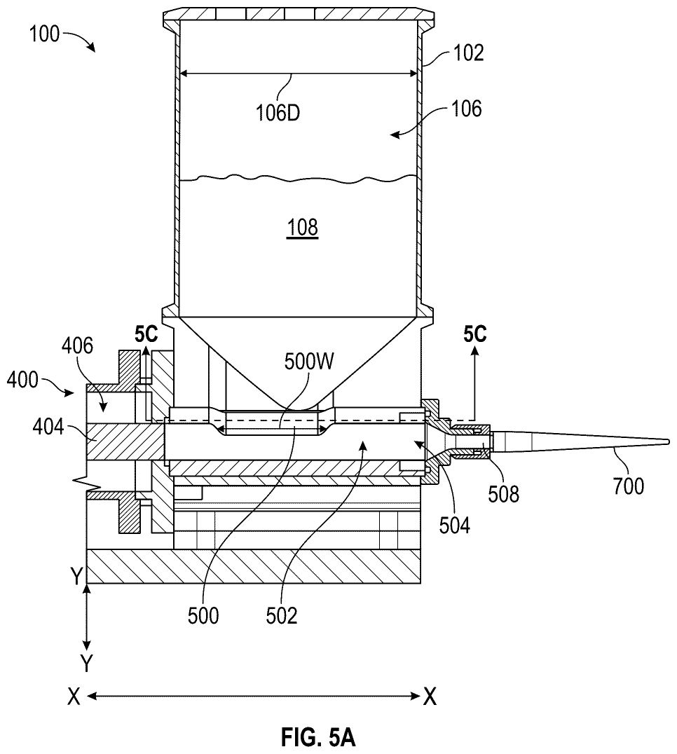

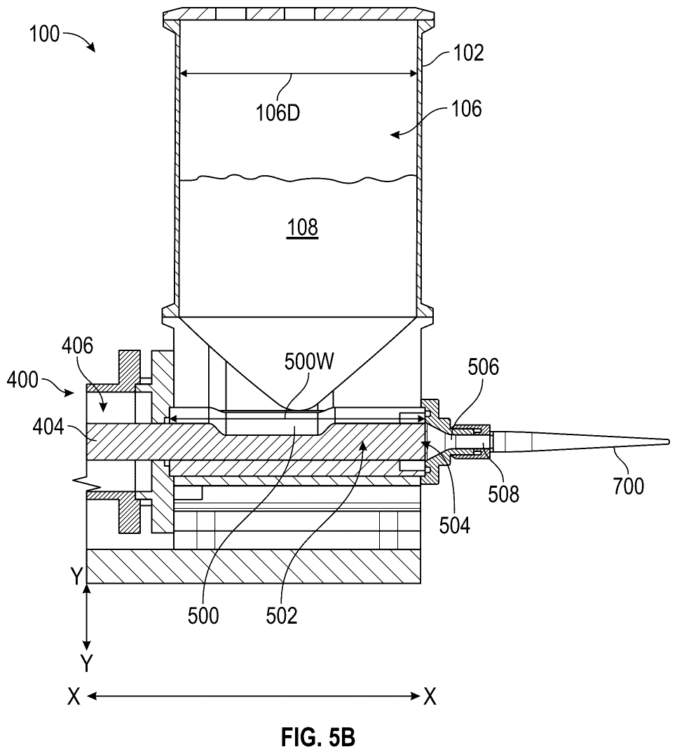

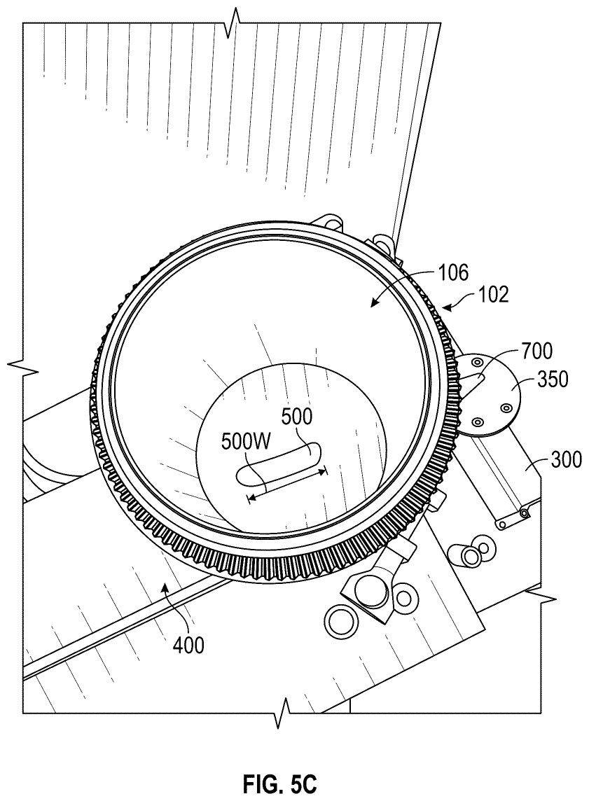

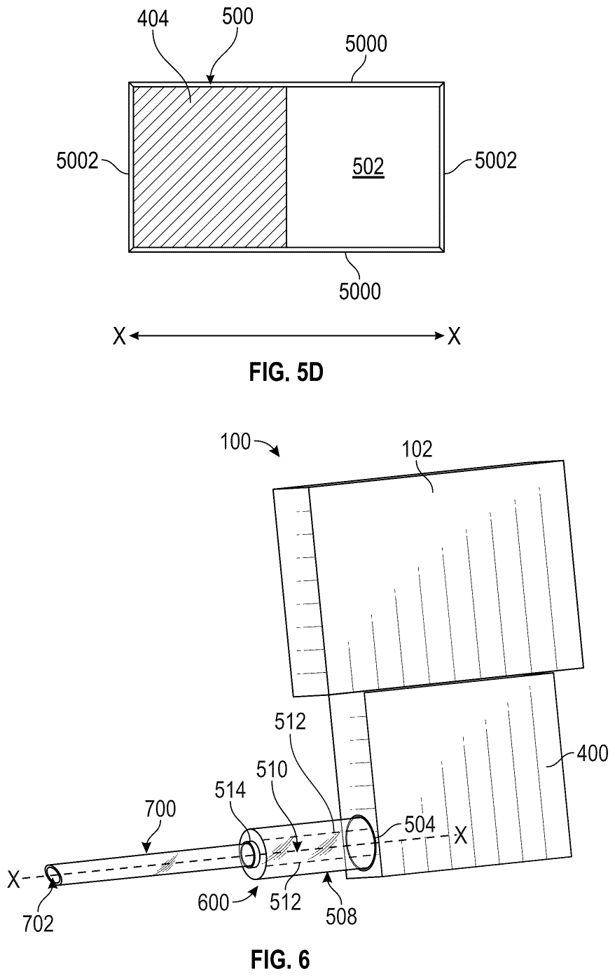

FIGS. 4, 5A, 5B, 5C, and 5D illustrate the injection system 100 that is operable to dispense the fluid (e.g., resin, oil, and/or terpene fluid) into the container 350.

As shown in FIGS. 4-5D, the injection system 100 can include a fluid reservoir 102 operable to contain the fluid. The fluid is operable to be dispensed from the reservoir 102 by an injection pump 400 into a conduit 508 and out of the tip 700.

The injection pump 400 is coupled to the fluid reservoir 102 such that the fluid flows into the injection pump 400 and is dispensed from the injection pump 400 out of a pump outlet 504 into the conduit 508. In at least one example, the injection pump 400 can include a motor 402, a housing 406, and a piston 404. The piston 404 can be at least partially received in the housing 406, and the piston 404 can translate within the housing 406 along the longitudinal axis X-X.

As shown in FIGS. 5A-5D, the fluid reservoir 102 includes a chamber 106 that receives and/or stores the fluid 108. The fluid reservoir 102 (e.g., the chamber 106) has a reservoir width 106D. The reservoir width 106D can span across the chamber 106 between the walls of the fluid reservoir 102. In at least one example, the fluid reservoir 102 can include a heater to keep the fluid 108 (e.g., oil) above a desired temperature to assist with dispensing, as some of the oils used might be slow flow type oils that dispensing at room temperature would take a long time to dispense.

The fluid 108 in the fluid reservoir 102 passes from the chamber 106 to the injection pump 400 through an outlet opening 500. For example, the injection pump 400 can include a passageway 502 in fluid communication with the outlet opening 500 such that the passageway 502 is operable to receive the fluid 108 from the fluid reservoir 102 (e.g., the chamber 106) via the outlet opening 500. In at least one example, the passageway 502 can be positioned below the outlet opening 500 along a vertical axis Y-Y that is transverse to the longitudinal axis X-X. Accordingly, the fluid 108 in the fluid reservoir 102 can drop into the passageway 502 through the outlet opening 500 with the help of gravity. In some examples, the fluid 108 can be deposited into the passageway 502 through the outlet opening 500 when a pressure is applied. In some examples, the fluid 108 can flow into the passageway 502 through the outlet opening 500 when a negative pressure is applied from the injection pump 400 (e.g., in the passageway 502).

FIGS. 5A-5D illustrates the outlet opening 500. In some examples, the outlet opening 500 can be formed by outlet walls 5000, 5002. The outlet walls 5000, 5002 can include two side walls 5002 that span between two longitudinal walls 5000. In some examples, the outlet walls 5000, 5002 can slope from the fluid reservoir 102 to the outlet opening 500 to funnel the material towards and into the outlet opening 500. In some examples, the outlet walls 5000, 5002 can be substantially in line with the walls of the fluid reservoir 102. For example, the outlet walls 5000, 5002 can mirror the shape of the fluid reservoir 102 but may be a different size.

Conventional reservoirs have openings that are small holes after the reservoir has been tapered down to a small point. This can cause inefficiencies when dispensing the fluid from the reservoir to the injection pump and out through the conduit. For example, the fluid contained in the conventional reservoir can form small skinny wells after the fluid flows out of the small hole of the reservoir. This creates a vacuum in the fluid. After some time, when the conventional injection pump tries to pull fluid from the reservoir, little to no fluid flows out of the conventional reservoir as the negative pressure formed by the injection pump 400 only pulls air through the vacuum of the small skinny wells.

In at least one example, as illustrated in FIGS. 5A-5D, the outlet opening 500 can be substantially rectangular in shape. In some examples, the outlet opening 500 can be substantially circular, oval, square, triangular, etc. in shape. For example, the outlet opening 500 can have a shape that substantially matches the shape of the fluid reservoir 102. Accordingly, the fluid 108 can flow out of the fluid reservoir 102 with more case, as the fluid 108 is not being compressed as much as a conventional reservoir.

The outlet opening 500 can have an outlet width 400 W. In at least one example, the outlet width 400 W can be greater than 20% of the reservoir width 106D. In at least one example, the outlet width 400 W can be greater than 25% of the reservoir width 106D. In at least one example, the outlet width 400 W can be greater than 30% of the reservoir width 106D. In at least one example, the outlet width 400 W can be greater than 40% of the reservoir width 106D. In at least one example, the outlet width 400 W can be greater than 50% of the reservoir width 106D. In some examples, the outlet width 400 W can be greater than 60% of the reservoir width 106D. In some examples, the outlet width 400 W can be greater than 70% of the reservoir width 106D. In some examples, the outlet width 400 W can be greater than 80% of the reservoir width 106D. In some examples, the outlet width 400 W can be greater than 90% of the reservoir width 106D. By having an outlet width 400 W that is larger, the fluid 108 can flow out of the chamber 106 of the fluid reservoir 102 with more case. Additionally, the presently disclosed injection system 100 prevents the formation of the skinny wells, as layers of the fluid 108 from the fluid reservoir 102 simply drop into the passageway 502 to be loaded for the injection pump 400 to dispense. This creates a more efficient and effective dispensing system of the fluid 108 through the injection system 100. Additionally, the injection system 100 lessens the amount of splitting of the fluid 108 which allows for more predictability and consistency of the dosage of the fluid 108 being dispensed.

In at least one example, the shape of the outlet opening 500 can substantially match the shape of the fluid reservoir 102, and the outlet width 400 D can be substantially similar (e.g., greater than 20%, 25%, 30%, 40%, 50%, 60%, 70%, 80%, or 90%) to the reservoir width 106D. Accordingly, the fluid 108 is efficiently and effectively dispensed into the passageway 502 of the injection pump 400 from the fluid reservoir 102.

In at least one example, the injection pump 400 can include a piston 404 that is operable to translate within the passageway 502 to dispense the fluid 108 that is received in the passageway 502. The piston 404 can be operable to transition between an extended configuration and a withdrawn configuration. For example, as illustrated in FIG. 5A, the piston 404 is shown in the withdrawn configuration where the piston 404 is not extended or is only just extended into the passageway 502. FIG. 5B illustrates the piston 404 in the extended configuration where the piston 404 is extended into the passageway 502, for example towards and/or adjacent to the pump outlet 504. When the piston 404 transitions from the withdrawn configuration to the extended configuration, the piston 404 is operable to push the fluid received in the passageway 502 out of the pump outlet 504. When the piston 404 transitions from the extended configuration to the withdrawn configuration, the fluid flows from the fluid reservoir 102 through the outlet opening 500 into the passageway 502. For example, when the piston 404 transitions from the extended configuration to the withdrawn configuration, a negative pressure in the passageway 502 can be created which draws the fluid 108 from the reservoir 102 into the passageway 502. In some examples, when the piston 404 transitions from the extended configuration to the withdrawn configuration, the piston 404 is withdrawn from the passageway 502 which creates empty space in the passageway 502. As the passageway 502 is positioned below the reservoir 102 along the vertical axis, gravity can help pull the fluid from the reservoir 102 into the passageway 502. In at least one example, the piston 404 can be operable to translate along the longitudinal axis when transitioning between the extended configuration and the withdrawn configuration. In some examples, the piston 404 can be operable to translate along the longitudinal axis X-X on a same plane as the passageway 502 and the channel 506 of the conduit 508.

The piston 404 translating along the longitudinal axis X-X on a same plane as the passageway 502 and the channel 506 of the conduit 508 allows for the fluid 108 to flow without excess pressure and force exerted onto the fluid 108. The fluid 108 only drops into the passageway 502 through the outlet opening 500 along a vertical axis Y-Y, and then gets pushed out by the piston 404 to be dispensed from the tip 700 along the longitudinal axis X-X that is substantially perpendicular to the vertical axis Y-Y. The fluid 108 is not encountering any turns or angles which prevents less closing and/or splitting of the fluid 108. Further, the amount of fluid 108 that is dispensed becomes more predictable and consistent, which provides for more accurate metering of the fluid 108 into the container 350.

Additionally, as the outlet opening 500 has such a large size and/or a shape that corresponds with the shape of the fluid reservoir 102, the fluid can more easily enter the passageway 502. More fluid can then be dispensed easily with less clogging, splitting of the fluid 108, and/or creation of wells in comparison to conventional injection systems.

In some examples, a pressure and/or a force may be applied to the fluid received in the fluid reservoir 102. For example, a pressure and/or a physical force may be applied to the top of the fluid in the fluid reservoir 102 to push the fluid towards and into the outlet opening 500 into the passageway 502. A physical force may include a lid or a barrier that covers the fluid that is lowered towards the outlet opening 500. In some examples, the lid or barrier may cover substantially the entirety of the fluid (e.g., the entirety of the chamber 106) so that the force applied is substantially evenly spread across the fluid.

In some examples, the injection pump 400 can be coupled with the controller 200 such that the controller 200 can control the amount of the fluid that is dispensed from the injection pump 400 and received in the container 350. The injection pump 400 can be operable to dispense a predetermined amount of the fluid into the container 350. For example, the injection system 4300 can be operable to dispense a predetermined amount of a total of 1 gram of the fluid into the container 350. The controller 200 can set the injection pump 400 to dispense a first amount which can be substantially equal to the predetermined amount of 1 gram. In some examples, the first amount can be performed by one piston stroke. However, the injection pump 400 and/or the fluid may cause the amount of fluid dispensed from the injection pump 400 of the first amount to be substantially equal to the predetermined amount (e.g., 1 gram) but not equal. For example, the consistency of the fluid and/or bubbles in the fluid may lead to the first amount to be less than (e.g., 5%, 10%, 18%, etc. less than) the predetermined amount. The container 350 can then be set on the load cell 300 which can measure the first amount of the fluid in the container 350. The controller 200 can receive the measurement of the first amount of the fluid in the container 350 and determine a second amount of the fluid to be dispensed into the container 350. The second amount of the fluid can be based on a difference between the first amount of fluid in the container and the predetermined amount. In some examples, the second amount of the fluid can be 0 grams. In some examples, the second amount of the fluid can be the 5%, 10%, 18%, etc. amount of the predetermined amount (e.g., 1 gram) to make up for the amount of the first amount being less than the predetermined amount. The controller 200 can then set the injection pump 400 to dispense the second amount of the fluid into the container 350 so that the container 350 contains the entirety of the predetermined amount (e.g., 1 gram) of the fluid. The controller 200 can determine the settings for the injection pump 400 via the type of fluid, type of injection pump 400, and/or other criteria so that the injection pump 400 dispenses the second amount of the fluid to have the container 350 receive the predetermined amount of the fluid.

The fluid then flows from the passageway 502 of the injection pump 400 through the pump outlet 504 into the conduit 508. The conduit 508 forms a channel 506 operable to permit the fluid to flow therethrough. In at least one example, the conduit 508 can be directly coupled with the pump outlet 504 of the injection pump 400 such that the fluid flows directly from the pump outlet 504 of the injection pump 400 into the channel 506 of the conduit 508.

As illustrated in FIGS. 5A-7A, the conduit 508 extends linearly along a longitudinal axis X-X. For example, the conduit 508 can extend parallel with the longitudinal axis X-X. Accordingly, the channel 506 does not include a turn (e.g., a 90 degree turn). The channel 506 extending linearly along the longitudinal axis X-X (e.g., without a turn) allows the fluid to flow through the channel 506 without separation of the solid(s) and liquid(s) in the fluid. For example, if the channel included turns as with conventional injection systems, the solid(s) in the fluid may remain in the turn while the liquid(s) move forward through the channel 506 to be dispensed. This can affect the concentration of the fluid and cause the fluid that is received in the container 350 to be undeliverable and unusable due to regulation criteria. For example, when the fluid includes hash resin, the resin that is deposited must be a certain concentration. If the resin is separated, then the product is undeliverable as the separation strips the resin of THC. The concentration is then unpredictable and/or lower than the product should be, even though the correct volume has been deposited into the container 350.

In at least one example, as shown in FIGS. 5A, 5B, and 6, the passageway 502 and the channel 506 extend linearly along the longitudinal axis X-X. In some examples, the passageway 502 and the channel 506 extend linearly along the longitudinal axis X-X on a same plane. Accordingly, the fluid is operable to flow from the passageway 502 into and through the channel 506 without a turn. This allows the fluid to flow through the injection pump 400 (e.g., through the passageway 502) and into the channel 506 without separation of the solid(s) and liquid(s) in the fluid. Additionally, this can allow for less blockage and more efficient and effective performance of the injection pump 400 with the piston 404 extending longitudinally to push the fluid along the longitudinal axis X-X to dispense the fluid.

In at least one example, the injection system 100 also includes the tip 700 that is operable to dispense the fluid into the container 350. The tip 700 can be coupled with the conduit 508 such that the fluid can flow from the conduit 508 directly into the tip 700. In at least one example, the tip 700 can be detachably coupled with the conduit 508 for easy replacement and/or cleaning. The fluid can then flow out of the tip 700 to be dispensed into the container 350. In at least one example, the tip 700 can include a needle. In some examples, the tip 700 can include a pipette tip.

As illustrated in FIGS. 5A-7B, the tip 700 can also extend along the longitudinal axis X-X. In some examples, similar to the conduit 508, the tip 700 does not include a turn (e.g., a 90 degree turn). In some examples, the tip 700 can extend linearly along the longitudinal axis X-X on the same plane as the passageway 502 and the channel 506. The tip 700 extending linearly along the longitudinal axis X-X (e.g., without a turn) on the same plane allows the fluid to flow through the tip 700 without separation of the solid(s) and liquid(s) in the fluid. For example, if the channel included turns, the solid(s) in the fluid may remain in the turn while the liquid(s) move forward through the tip 700 to be dispensed into the container 350. Moreover, the fluid does not encounter any turns as the fluid flows from the channel 506 of the conduit 508 into and through the tip 700. This further improves the fluid properties, as the fluid is less likely to separate if at all.

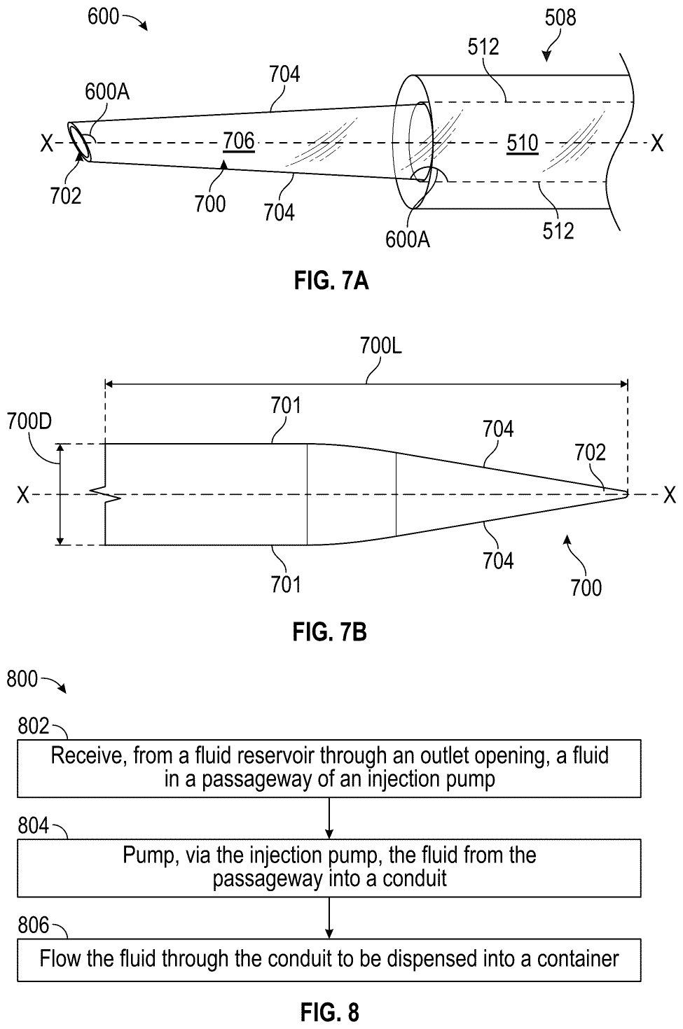

As illustrated in FIG. 7A, in at least one example, the tip 700 can include tip walls 704 that form a tip channel 706. The tip channel 706 can be operable to receive the fluid from the channel 4320 of the conduit 508 such that the fluid can flow through the tip channel 706 out of an exit opening 702 through which the fluid is dispensed.

In at least one example, while the tip channel 706 and the tip 700 extend along the longitudinal axis X-X, the tip walls 704 can taper towards the exit opening 702. For example, the tip 700 can have substantially a conical or a frustoconical shape (not considering the exit opening 702). In some examples, the tip 700 can have substantially a pyramidal shape. In some examples, the tip walls 704 can taper at a taper angle 600A in relation to the longitudinal axis X-X. While FIG. 7A illustrates the taper angle 600A being in relation to the conduit walls 512, the conduit 512 walls are parallel to the longitudinal axis X-X, so the taper angle 600A is also equivalently tapered in relation to the longitudinal axis X-X.

In at least one example, the tip walls 704 can taper at the taper angle 600A in relation to the longitudinal axis X-X that is greater than about 135 degrees. In some examples, the taper angle 600A can be equal to or less than about 180 degrees. In some examples, the taper angle 600A can be between about 135 degrees and about 180 degrees. In some examples, the taper angle 600A can be between about 145 degrees and about 180 degrees. In some examples, the taper angle 600A can be between about 155 degrees and about 180 degrees. In some examples, the taper angle 600A can be between about 165 degrees and about 180 degrees. In some examples, the taper angle 600A can be between about 175 degrees and about 180 degrees. Accordingly, the linear pathway provided by the conduit 508 and the tip 700 does not contract at a steep angle (e.g., between 135 degrees and 90 degrees). By having a gradual taper of the tip 700 with the taper angle 600A, the injection system 500 can be depressurized. If the taper angle 600A was steeper, the injection system 500 can be pressurized and cause separation. For example, with a stepper taper angle 600A, the fluid would be pushed against the taper walls 704 which creates pressure on the fluid as the fluid slides down the taper walls 704 towards the exit opening 702. The pressure on the fluid can cause the fluid to separate, and at least a portion of the solid(s) may remain on the taper walls 704 while the liquid(s) may flow out of the exit opening 702 to be disposed into the container 350. This can affect the concentration of the fluid and cause the fluid that is received in the container 350 to be undeliverable and unusable due to regulation criteria.

In some examples, the tip walls 704 may not taper, and extend substantially parallel with the longitudinal axis X-X (e.g., a taper angle 600A of about 180 degrees). Accordingly, the tip walls 704 may continue in parallel with the conduit walls 512.

In at least one example, at least a portion of the tip 700 can be made of plastic. For example, at least a portion of the tip 700 can be made of low density polyethylene and/or polypropylene. In at least one example, the tip 700 can be operable to be cut to form the exit opening 702 through which the fluid is dispensed. By being able to cut the tip 700, the desired size and/or shape of the exit opening 702 can be formed. For example, as shown in FIG. 7A, the exit opening 702 can extend at an exit angle 702A that is greater than 90 degrees in relation to the longitudinal axis X-X. In some examples, the exit angle 702A can be between about 90 degrees and about 180 degrees. In some examples, the exit angle 702A can be between about 95 degrees and about 180 degrees. In some examples, the exit angle 702A can be between about 120 degrees and about 180 degrees. In some examples, the exit angle 702A can be between about 150 degrees and about 180 degrees.

With such an exit angle 702A for the exit opening 702, the fluid can flow easily out of the exit opening 702 to be received in the container 350. Additionally, in some examples, the fluid may need to be scraped into the container 350. With such an exit angle 702A, the fluid can be easily scraped into the container 350 while preventing excess dripping of the fluid. For example, the container 350 may be raised to the exit opening 702 of the tip 700 for dispensing of the fluid into the container 350. Once the injection pump 400 finishes pumping the desired amount of fluid, the fluid at the exit opening 702 of the tip 700 can be scraped off and deposited into the container 350. The amount of the fluid that is dispensed and received in the container 350 is as desired.

In at least one example, the tip 700 being at least partially made of plastic allows the tip 700 to be cut to obtain the desired size and shape of the exit opening 702. For example, if the exit opening 702 is too large, the fluid may drip out of the tip 700. If the exit opening 702 is too small, the fluid may not flow out of the tip 700 via the exit opening 702, which can lead to pressure buildup and subsequently separation of the fluid. Accordingly, the tip 700 is a variable size nozzle that can be cut and manipulated as fit for the fluid, the container 350, and/or the injection pump 400.

In at least one example, the tip 700 can be detachably coupled with the conduit 508. Accordingly, the tip 700 can be replaceable which can improve ease of maintenance. In some examples, the tip 700 being detachably coupled can assist with ensuring that the exit opening 702 is the desired and appropriate size. For example, if the exit opening 702 that is cut is not as desired, the tip 700 can be detached and discarded, and a new tip 700 can be attached to the conduit 508.

As illustrated in FIG. 7B, the tip 700 may not taper the entire length 700L of the tip 700. The tip 700 may have a parallel portion where the walls 701 extend substantially parallel to one another then a taper portion where the walls 704 taper towards the exit opening 702. In at least one example, the parallel portion can be proximate the conduit 508 and be between the conduit 508 and the taper portion. In at least one example, the parallel portion can have a width 700D between about 7 millimeters and about 21 millimeters. In some examples, the parallel portion can have a width 700D between about 11 millimeters and about 18 millimeters. In some examples, the parallel portion can have a width 700D between about 13 millimeters and about 15 millimeters. In some examples, the parallel portion can have a width 700D about 14 millimeters. Having a wide opening into the parallel portion can allow for an easier transition for the fluid to flow from the conduit 508 into the tip 700. In some examples, the tip 700 can have a length 700L between about 45 millimeters and about 80 millimeters. In some examples, the tip 700 can have a length 700L between about 55 millimeters and about 75 millimeters. In some examples, the tip 700 can have a length 700L between about 60 millimeters and about 70 millimeters. In some examples, the tip 700 can have a length 700L between about 64 millimeters and about 66 millimeters. In some examples, the tip 700 can have a length 700L about 46.50 millimeters.

Referring to FIG. 8, a flowchart is presented in accordance with an example embodiment. The method 800 is provided by way of example, as there are a variety of ways to carry out the method. The method 800 described below can be carried out using the configurations illustrated in FIGS. 1A-7B, for example, and various elements of these figures are referenced in explaining example method 800. Each block shown in FIG. 8 represents one or more processes, methods, or subroutines, carried out in the example method 800. Furthermore, the illustrated order of blocks is illustrative only and the order of the blocks can change according to the present disclosure. Additional blocks may be added or fewer blocks may be utilized, without departing from this disclosure. The example method 800 can begin at block 802.

At block 802, fluid is received from a fluid reservoir through an outlet opening in a passageway of an injection pump. The outlet opening has an outlet width that is greater than 20% of a reservoir width.

At block 804, the injection pump pumps the fluid from the passageway into a conduit. The passageway and the conduit extend linearly along a longitudinal axis. In at least one example, the passageway and a channel for the conduit can extend along the longitudinal axis on a same plane. The channel can be formed in the conduit to permit fluid to pass therethrough.

In at least one example, to pump the fluid, a piston of the injection pump can be transitioned between an extended configuration and a withdrawn configuration. When the piston transitions from the withdrawn configuration to the extended configuration, the piston is operable to push the fluid received in the passageway out of the pump outlet. When the piston transitions from the extended configuration to the withdrawn configuration, the fluid flows from the fluid reservoir through the outlet opening into the passageway. In at least one example, the piston can translate along the longitudinal axis. In some examples, the piston can translate along the longitudinal axis on the same plane as the passageway and the channel.

At block 806, the fluid flows through the conduit to be dispensed into a container.

In at least one example, a tip can be detachably coupled with the conduit. The tip can extend linearly along the longitudinal axis. In at least one example, the tip extends along the longitudinal axis on a same plane as the passageway and the channel.

While the above example shows implementation with a single fluid reservoir 102, controller 200, container 350, load cell 300, and injection pump 400, the present technology can be implemented with a plurality of fluid reservoirs, controllers, containers, load cells, and/or injection pumps.

While examples of the present inventive concept have been shown and described herein, it will be obvious to those skilled in the art that such examples are provided by way of example only. Numerous variations, changes, and substitutions will now occur to those skilled in the art without departing from the disclosure. It should be understood that various alternatives to the examples of the disclosure described herein can be employed in practicing the disclosure. It is intended that the following claims define the scope of the disclosure and that methods and structures within the scope of these claims and their equivalents be covered thereby.

What is claimed is:

1. An injection system comprising:
a fluid reservoir operable to contain a fluid, the fluid reservoir having a reservoir width, the fluid reservoir including an outlet opening that has an outlet width, the outlet width being greater than 20% of the reservoir width;
an injection pump coupled to the fluid reservoir, the injection pump including a passageway in fluid communication with the outlet opening such that the passageway is operable to receive the fluid from the fluid reservoir via the outlet opening, the injection pump operable to dispense the fluid from the passageway through a pump outlet;
a conduit in fluid communication with the injection pump, the conduit forming a channel operable to receive the fluid dispensed from the passageway, the channel operable to permit the fluid to flow therethrough,
wherein the passageway and the channel extend linearly along a longitudinal axis.

2. The injection system of claim 1, wherein the passageway and the channel extend along the longitudinal axis on a same plane.

3. The injection system of claim 1, wherein the passageway is positioned below the outlet opening along a vertical axis.

4. The injection system of claim 1, wherein the conduit is directly coupled with the pump outlet of the injection pump.

5. The injection system of claim 1, wherein fluid is operable to flow from the passageway into and through the channel without a turn.

6. The injection system of claim 1, wherein the outlet width is greater than 80% of the reservoir width.

7. The injection system of claim 1, further comprising a tip coupled with the conduit such that the fluid flows out of the tip to be dispensed into a container.

8. The injection system of claim 7, wherein the tip is detachably coupled with the conduit.

9. The injection system of claim 7, wherein the tip extends linearly along the longitudinal axis.

10. The injection system of claim 9, wherein the tip extends along the longitudinal axis on a same plane as the passageway and the channel.

11. The injection system of claim 1, wherein the injection pump includes a piston that is operable to translate within the passageway to dispense the fluid.

12. The injection system of claim 11, wherein the piston transitions between an extended configuration and a withdrawn configuration, wherein when the piston transitions from the withdrawn configuration to the extended configuration, the piston is operable to push the fluid received in the passageway out of the pump outlet.

13. The injection system of claim 12, wherein when the piston transitions from the extended configuration to the withdrawn configuration, the fluid flows from the fluid reservoir through the outlet opening into the passageway.

14. A method comprising:
receiving, from a fluid reservoir through an outlet opening, a fluid in a passageway of an injection pump;
pumping, via the injection pump, the fluid from the passageway into a conduit;
flowing the fluid through the conduit to be dispensed into a container,
wherein the passageway and the conduit extend linearly along a longitudinal axis,
wherein the outlet opening has an outlet width that is greater than 20% of a reservoir width.

15. The method of claim 14, wherein the passageway and a channel for the conduit extend along the longitudinal axis on a same plane.

16. The method of claim 14, wherein the pumping of the fluid includes:
transitioning a piston of the injection pump between an extended configuration and a withdrawn configuration.

17. The method of claim 16, wherein when the piston transitions from the withdrawn configuration to the extended configuration, the piston is operable to push the fluid received in the passageway out of the pump outlet.

18. The method of claim 16, wherein when the piston transitions from the extended configuration to the withdrawn configuration, the fluid flows from the fluid reservoir through the outlet opening into the passageway.

19. The method of claim 14, further comprising:
detachably coupling a tip with the conduit, wherein the tip extends linearly along the longitudinal axis.

20. The method of claim 19, wherein the tip extends along the longitudinal axis on a same plane as the passageway and a channel.
